(19) United States
(12) Patent Application Publication
(10) Pub. No.: US 2004/0179427 A1
(43) Pub. Date: Sep. 16, 2004

(54) Method and apparatus for chemical analysis

(76) Inventors: Takeo Yamazaki, Kanagawa (JP); Naoto Mihashi, Tokyo (JP); Takeshi Imamura, Kanagawa (JP); Satoko Omizu, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/480,045

(22) PCT Filed: Jul. 10, 2003
(86) PCT No.: PCT/JP03/08760

(30) Foreign Application Priority Data
Jul. 18, 2002 (JP) 2002-210213

(51) Int. Cl. B01F 13/02; B01J 19/24; B01L 3/00

(52) U.S. Cl. 366/348; 366/262; 366/144; 366/341; 210/198.2; 366/106

(57) ABSTRACT

A method of mixing plural liquids in a liquid chamber is provided which comprises steps of introducing plural liquids into the liquid chamber, and repeating expansion and shrinkage of a bubble in the liquids in the liquid chamber. In this method, the liquid may be heated to produce the bubble. A liquid-mixing apparatus for mixing plural liquids in a liquid chamber to obtain a liquid mixture is also provided. The liquid-mixing apparatus comprises a liquid chamber; flow channels for introducing the plural liquids into the liquid chamber; a heating part placed in the liquid chamber for heating the liquid mixture in the liquid chamber; and an energy-supplying means for causing expansion and shrinkage of a bubble in the liquid mixture in the liquid chamber.

### TECHNICAL FIELD

The present invention relates to a chemical analysis method and an apparatus therefor. More specifically, the present invention relates to a chemical analysis method and an apparatus for mixing plural liquids efficiently in a miniaturized analysis system (μTAS: Micro Total Analysis System) on a chip for conducting chemical analysis or chemical synthesis.

### BACKGROUND ART

With the development of three-dimensional fine processing technique in recent years, the systems are attracting attention which comprise fluid elements such as a fine flow channel, a pump, and a valve; and a sensor integrated on a substrate like glass or silicon and conduct chemical analysis on the substrate. Such a system is called a μ-TAS (Micro Total Analysis Systems) or a Lab on-a Chip. The miniaturization of a chemical analysis system enables decrease of dead volume and remarkable decrease of the sample consumption as well as shortening of the analysis time and decrease of energy consumption of the entire system. Further, the miniaturization is promising for lowering the price of the system. Furthermore, the μ-TAS is promising in medical services such as home medial care and bed-side monitoring, and biological techniques such as DNA analysis and proteome analysis.

Japanese Patent Application Laid-Open No. 10-337173 discloses a micro-reactor which is suitable for conducting a sequence of biochemical experimental steps comprising mixing and reaction of solutions, determination and analysis, and separation, by utilizing combination of several cells. FIG. 6 illustrates schematically concept of micro-reactor 601. Micro-reactor 601 has an isolated reaction chamber sealed with a flat plate on a silicon substrate. This micro-reactor has reservoir cell 602, mixing cell 603, reaction cell 604, detection cell 605, and separation cell 606 in combination. In mixing-cell 603, plural liquids are mixed by diffusion of the respective fluid particles at the interface between the liquids. By providing such a reactor in plurality on a substrate, many biochemical reactions can be allowed to proceed simultaneously and parallel. Not only the analysis, but material synthesis such as protein synthesis can be conducted in a reactor.

Japanese Patent Application Laid-Open No. 2001-252897 describes, in the description of Prior Art, a mixing-stirring mechanism employing a piezoelectric element. This mixing-stirring mechanism 801, as shown in FIG. 8, has silicon diaphragm (thin layer) 803 formed as the bottom plane of the mixing room 802, and piezoelectric element 804 like PZT in close contact with the lower face of diaphragm 803. The mixing of a sample liquid and a reagent in mixing cell 802 is accelerated by-vibration of PZT 804 caused by application of a pulse voltage and application of the vibration through diaphragm 803 to the sample solution and the reagent solution.

Japanese Patent Application Laid-Open No. 2001-252897 further discloses a mixing-stirring mechanism utilizing a light pressure caused by light irradiation as rotational driving force in a mixing room. FIG. 9 shows the mixing-stirring mechanism. In the mixing-stirring operation, rotation of light pressure mixer 902 mixes actively and directly the sample solution and the reagent solution introduced respectively through inlets 903 and 904 in mixing room 901.

The above-described mixing technique has problems to be solved as shown below.

In micro-reactor 601 shown in FIG. 6, plural liquids are introduced from reservoir cell 602 to mixing cell 603. The liquids are mixed well by diffusion between the liquids in the mixing cell 603, and the mixture is introduced into reaction cell 604. If the mixing of the liquids in mixing cell 603 is not sufficient, the reaction in reaction cell 604 can be instable and the results of detection or isolation can-be instable. For complete mixing of the liquids by diffusion, the length of the cell should be increased in the direction parallel to the flow in the mixing cell 603. This requires a larger area for forming micro-reactor 601. In particular, in formation of many micro-reactors on a substrate, the larger area limits the number of micro-reactors formable on one substrate and the number of the chemical reaction conducted on one substrate simultaneously and parallel, which results in lower efficiency of the chemical analysis.

The mixing-stirring mechanism employing a piezoelectric element as shown in FIG. 8 conducts stirring indirectly. Therefore, its mixing efficiency is limited, and cannot achieve sufficient effects in microanalysis employing a microanalysis chip.

The mixing-stirring mechanism employing a light pressure mixer shown in FIG. 9 has light pressure mixer 902 placed in mixing room 901. This requires sufficient space for rotation of light pressure mixer 902 in mixing room 901, limiting the design. Further, when the mixing-stirring is not conducted, the light pressure mixer becomes a spatial barrier, which may cause clogging of the fine flow cannel.

Japanese Patent Application Laid-Open No. 2001-252897 discloses a modification in which light pressure mixer 902 is put aside into housing room 905 after completion of the mixing-stirring. However, the volume of the housing room 905 can become a dead volume. Further, during mixing and stirring by rotation of light pressure mixer 902 in mixing room 901, the mixing efficiency of the liquid existing in housing room 905 is estimated to be lower. Furthermore, in and around housing room 905, the stirring of the liquid can be insufficient locally. This can affect adversely the mixing and reaction in mixing room 901.

### DISCLOSURE OF THE INVENTION

The present invention has been made in view of the above problems. The present invention intends to provide a method for chemical analysis in which plural liquids are stirred efficiently and mixed uniformly by repetition of expansion and shrinkage of a bubble in a liquid, and an apparatus for the method.

The present invention intends also to provide a method for chemical analysis which enables size reduction of a mixing vessel for mixing liquids in comparison with conventional mixing vessels which mix liquids by diffusion only, enabling miniaturization of the device, and an apparatus for the method.

The present invention intends further to provide a method for chemical analysis in which chemical reactions conducted simultaneously and parallel in a larger number on one substrate to improve the efficiency of chemical analysis, and to provide an apparatus for the method.

The present invention intends still further to provide a method for chemical analysis in which a stirring mechanism will not become spatial barrier in a fine flow cannel and clogging will not be caused in the fine flow cannel, and to provide an apparatus for the method.

The present invention still further intends to provide a method of chemical analysis in which a dead volume or an insufficiently stirred portion will not be caused in a mixing vessel by a stirring mechanism, and to provide an apparatus therefore.

According an aspect of the present invention, there is provided a method of mixing liquids in a liquid chamber, comprising introducing liquids into the liquid chamber, and repeating expansion and shrinkage of a bubble in the liquids in the liquid chamber.

According to another aspect of the present invention, there is provided a liquid-mixing apparatus for mixing liquids in a liquid chamber, comprising a liquid chamber, flow cannels for introducing liquids into the liquid chamber, a heating part placed in the liquid chamber for heating the liquids in the liquid chamber, and an energy-supplying means for causing expansion and shrinkage of a bubble in the liquids in the liquid chamber.

### BRIEF DESCRIPTION OF THE DRAWINGS

FIG. 1 is a schematic drawing which illustrates an example of an embodiment of the chemical analysis apparatus of the present invention.

FIG. 2 is a schematic drawing which illustrates an example of another embodiment of the chemical analysis apparatus of the present invention.

FIGS. 3A and 3B are schematic drawings which illustrate the chemical analysis apparatus of the present invention.

FIGS. 4A, 4B, and 4C are drawings which illustrate a process of producing a chemical analysis apparatus of the present invention.

FIG. 5 is a schematic drawing which illustrates an example of the chemical analysis apparatus of the present invention.

FIG. 6 is a schematic drawing which illustrates a chemical analysis apparatus (micro-reactor) of prior art.

FIG. 7 is a schematic drawing which illustrates a constitution of a heating element of the present invention.

FIG. 8 is a drawing which illustrates a mixing-stirring mechanism of prior art employing a piezoelectric element.

FIG. 9 is a drawing which illustrates a mixing-stirring mechanism of prior art employing a light pressure mixer.

FIGS. 10A and 10B are schematic drawings for explaining a method for mixing liquids of the present invention.

### BEST MODE FOR CARRYING OUT THE INVENTION

The present invention is explained below in detail.

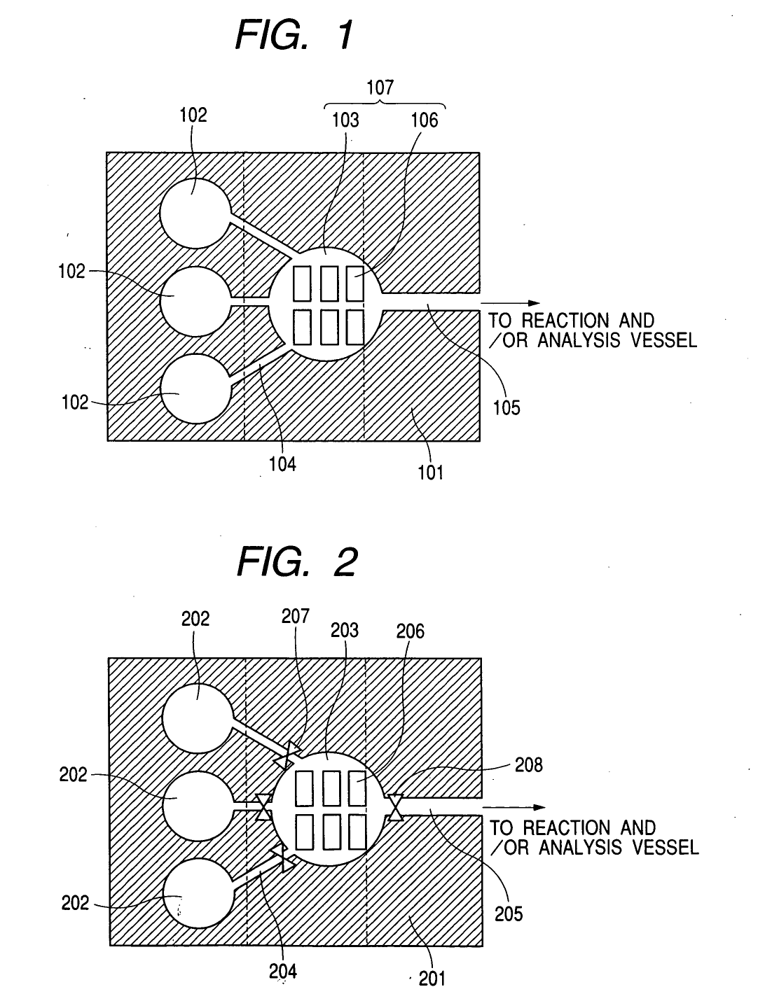

FIG. 1 is a schematic drawing which illustrates an example of an embodiment of the chemical analysis apparatus of the present invention. In FIG. 1, plural liquid samples are injected from sample injection vessels 102 through flow cannels 104 into a mixing vessel 103. The plural liquid samples are mixed in mixing vessel 103 by mixing means 107, the mixing means comprising at least one heating element 106 provided at uniform intervals on the bottom face of mixing vessel 103 and being driven independently. The resulting mixture is delivered through flow cannel 105 to a reaction and/or analysis vessel (not shown in the drawing). The vessels and the flow cannels are sealed tightly by bonding a cover plate (not shown in the drawing) onto the substrate. Sample inlets (not shown in the drawing) are formed for introducing samples on portions of the cover plate opposing the sample injection vessels.

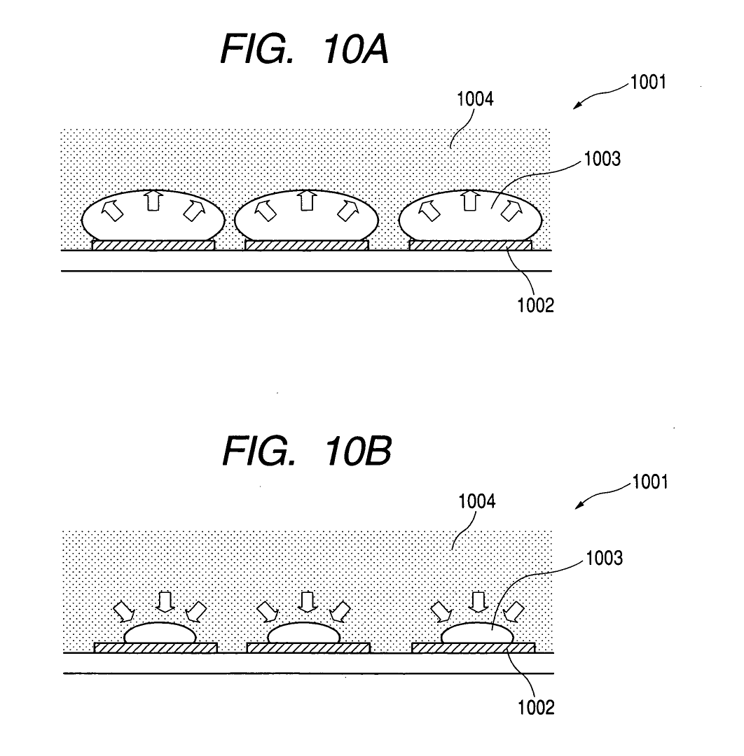

The method of liquid mixing of the present invention is explained by reference to FIGS. 10A and 10B. FIGS. 10A and 10B are partial schematic drawings of the mixing vessel. Heating elements are provided on the bottom face of mixing vessel 1001. The heating element comprises thin-film resistor 1002 and electrode (not shown in the drawing) for applying a pulse voltage to the thin-film resistor. As shown in FIG. 10A, with liquid 1004 introduced into mixing vessel 1001, bubble 1003 is produced by applying a pulse voltage to thin film resistor 1002 to heat the liquid rapidly up to a film-boiling temperature. The produced bubble 103 expands quickly. The expanded bubble will soon shrink as shown in FIG. 10B, and will disappear with lapse of time. The time from the generation to disappearance of the bubble is in the range from several μsec to about 20 μsec and the expansion (state of FIG. 10A) and shrinkage (state of FIG. 10B) can be repeated at a frequency of 10-odd kHz at the maximum. In the present invention, the liquids in the mixing vessel are mixed, in addition to the usual liquid diffusion, by directly stirring the liquid in the mixing vessel by repetition of expansion and shrinkage of the bubble. Thereby, the mixing can be conducted at high efficiency in comparison with the mixing in prior art techniques.

The size of the produced bubble can be changed by controlling the pulse voltage level or the pulse width. Thereby the pulse voltage or the pulse width can be set at an optimum level depending on, for example, the kind of the liquids. Otherwise by changing the pulse voltage level or the pulse width during the stirring the mixing can be conducted more efficiently.

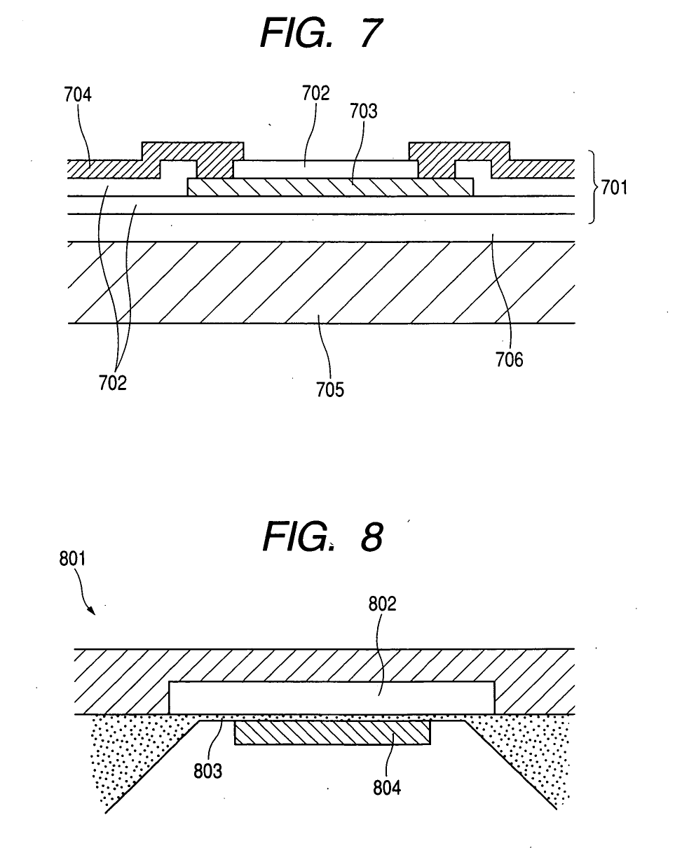

A specific example of constitution of the heating element is shown in FIG. 7. In the constitution, heating element 701 is formed on substrate 705, and thin-film resistor 703 is held at the upper and lower faces thereof between protecting layers 702. The-material of thin-film resistor 703 includes metallic materials and semiconductors such as electroconductive silicon. Protecting layer 702 is capable of protecting the surface of the thin-film resistor from the chemical reaction. The material of protecting layer 702 has preferably high chemical resistance, including insulation materials such as SiO₂, and Si₃O₄; and metallic materials such as Ta. Both ends of the thin-film resistor are connected to electrodes 704 electrically through contact holes formed on protecting layer 702. A bubble can be produced by application of a pulse voltage through electrodes 704 to the both terminals of the thin-film resistor. Heat storage layer 706 is formed between substrate 705 and heating element 701 to prevent dissipation of the heat generated by the heating element to substrate 705. Thereby the bubble can be produced effectively.

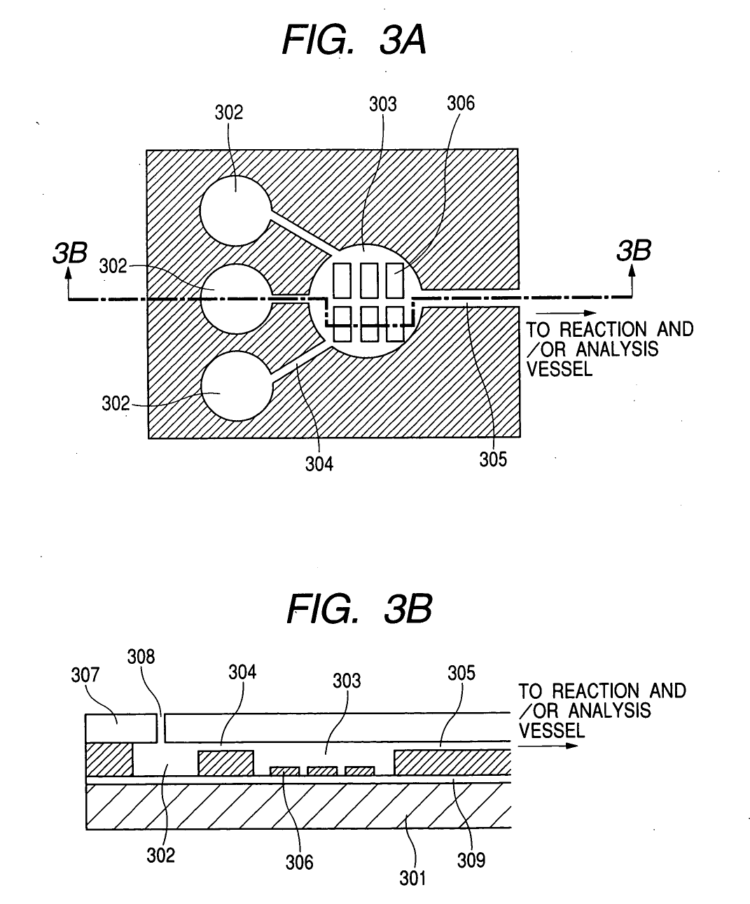

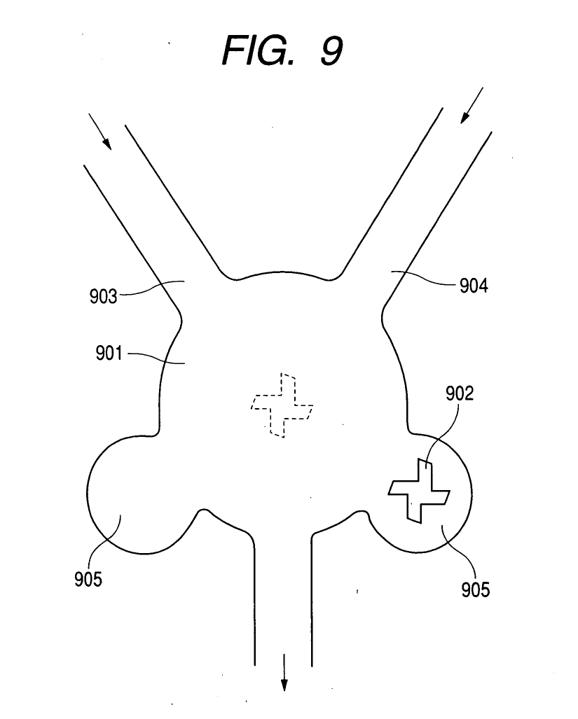

The heating element, namely the mixing-stirring mechanism, of the present invention, which is comprised of thin-film resistor 703 and thin-film protecting layer 702, is less liable to become a spatial barrier against the liquid flow, differently from that of the prior art shown in FIG. 9. Therefore, the design is restricted less by the arrangement of the heating element. Further, a housing room or the like for retracting a mixing mechanism as that of the prior art need not be provided. Therefore, no dead volume is caused, and the stirring of the liquid may not become insufficient around the housing room. Incidentally, in FIGS. 3, 4, and 7, the heating element is shown with enlargement in the layer thickness direction for convenience of explanation. The actual film thickness of the practical heating element is, for example, in the range of about 2 to about 3 μm for the depth of the mixing vessel of from several hundred μm to several ten μm.

The heating element is not specially limited in its position provided that it is in contact with the liquid in the mixing vessel. Preferably the heating element is placed on the bottom face or the wall face. In consideration of the efficiency in stirring and mixing, the element is preferably arranged uniformly on the entire region of the face constituting the mixing vessel. If the heating element is not readily formable over the entire region of the face constituting the mixing vessel, the heating element is preferably formed on the largest portion of the face, for example, over the entire region of the bottom face.

With plural heating elements arranged, preferably the heating elements are designed to be independently drivable respectively. Thereby the driving manner can be changed depending on the shape of the mixing vessel and the state of the liquid, i.e., for example, alternate driving of adjacent heating elements; and alternate driving of heating elements in the center portion of the mixing vessel and those in the peripheral portions. By such driving, the efficiency of stirring and mixing of the liquid can be raised.

FIG. 2 is a schematic drawing which illustrates another example of embodiment of the chemical analysis apparatus of the present invention. In this embodiment, valves 207 are provided at respective flow channels 204 connecting the sample injection vessels 202 and mixing vessel 203, and valve 208 is provided at flow channel 205 delivering the liquid mixed at mixing vessel 203 to a reacting vessel or a detecting vessel. In mixing the liquids at mixing vessel 203 in the chemical analysis apparatus shown in FIG. 2, valve 207 and valve 208 are closed to isolate completely mixing vessel 203 and in this state the expansion-shrinkage of the bubble is repeated. The closure of the valves prevents the movement of the liquid from mixing vessel 203 toward flow channels 204 or flow channels 205, enabling efficient mixing of the liquid in comparison with mixing in the vessel with valve-less open flow channels. After complete mixing, valve 208 is opened to deliver the liquid mixture to the reacting or analyzing vessel.

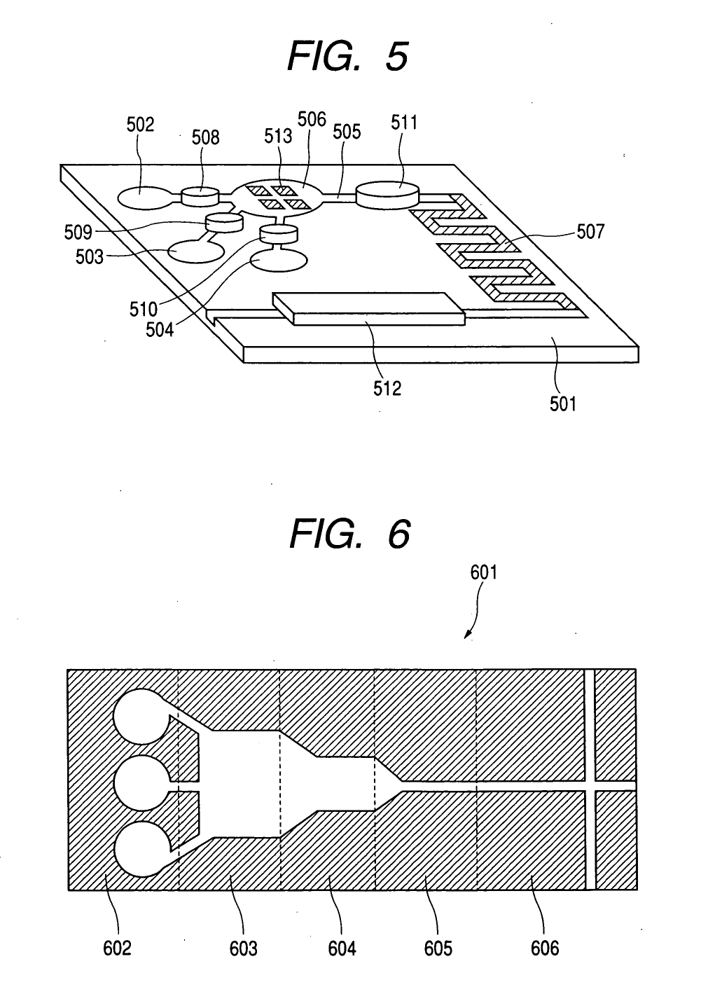

The chemical analysis apparatus as an example Of the present invention illustrated in FIG. 5 has a separation section and a detection section as analysis means on one substrate 501 in addition to the sample injection vessel and the mixing vessel. With this apparatus, a sample to be analyzed is introduced from any of sample injection vessels 502 to 504, for example, 502, and a mobile phase (or a carrier phase) is introduced from sample injection vessel 503. The flow rate of the mobile phase is controlled by opening of valve 509 as a fluid element. The flow rate of the sample may be adjusted by controlling the opening of valve 508. When sample injection vessel 504 is used, the flow rate can be controlled by valve 510. The sample and the mobile phase thus introduced into the apparatus are mixed in the mixing vessel 506. The mixing is caused by driving heating element 513 provided on the bottom face of the mixing vessel to repeat the expansion and shrinkage of the bubble. The mixed liquid is delivered to separation section 507 through flow channel 505 by pump 511. There, components of the sample are separated. The method of the separation includes liquid chromatography, and electrophoresis. The sample separated into the components is subjected to detection in detection section 512. The method of the detection-includes electrochemical detection, and fluorescence detection. The sample after the detection is discharged as a waste liquid out of the substrate. Incidentally, in FIG. 5, an atmosphere-intercepting part for isolating the apparatus system from the outside air is omitted.

The chemical analysis method and apparatus of the present invention makes possible uniform mixing of plural liquids efficiently by stirring and mixing by expansion and shrinkage of a bubble caused by a heating element provided in a mixing vessel. Thereby, the size of the mixing vessel can be made smaller in comparison with the one for mixing by diffusion only, whereby the device can be made smaller. Further, a larger number of devices can be provided on one substrate, whereby a chemical reaction can be carried out simultaneously and parallel in a larger number on one substrate to enable efficient experiment.

The method and apparatus for chemical analysis of the present invention has advantages below.

The mixing-stirring mechanism is less liable to become a spatial barrier, so that clogging of the fine flow channel is less liable to occur.

A housing room for retracting the mixing-stirring mechanism is not necessary even when the mixing-stirring is not conducted, so that no dead volume is formed.

The absence of the housing room prevents occurrence of nonuniform flow around the housing room, and prevents drop of the efficiency of the mixing in the mixing vessel and drop of the efficiency of the reaction.

### EXAMPLE

The present invention is explained below in more detail by reference to Examples. The dimensions, the shaped, the materials, and the production process conditions in Examples are merely for exemplification, and can be modified as design items within the range satisfying the requirements of the present invention.

### Example 1

A chemical analysis apparatus was prepared, and liquids were mixed by using the prepared chemical analysis apparatus. FIGS. 3A and 3B illustrate the chemical analysis apparatus of this Example. FIG. 3A is a plan view of the chemical analysis apparatus. FIG. 3B is a sectional view taken along alternate long and short dash line 3B-3B in FIG. 3A. As shown in FIGS. 3A and 3B, the chemical analysis apparatus of this Example is comprised of sample injection vessels 302, mixing vessel 303, flow channels 304 connecting sample injection vessels 302 and mixing vessel 303, and flow channel 305 for introducing the liquid mixed in the mixing vessel to a reaction and/or analysis vessel, formed on a silicon substrate 301 (25 mm×30 mm) having SiO₂ film 309 on the surface. On the bottom face of mixing vessel 303, heating elements 306 are formed. The vessels are sealed by glass base plate 307. Sample inlets 308 are formed through glass base plate 307 for introduction of samples into sample injection vessels 302.

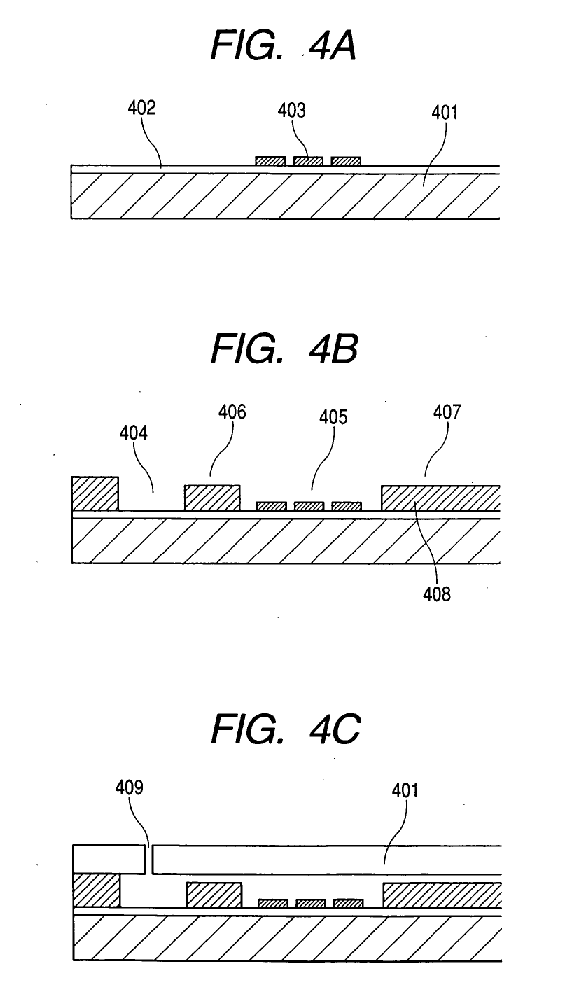

Next, the process of producing a chemical analysis apparatus of the present invention is explained by reference to FIGS. 4A to 4C.

On silicon substrate 401, SiO₂ film 402 was formed by thermal oxidation in a thickness of 1.0 μm. Formed SiO₂ film 402 serves to prevent dissipation of the heat generated by heating element 403 to substrate 401 but to utilize the generated heat effectively for bubble formation. Heating elements 403 comprised of a thin-film resistor, a protection layer and electrodes for applying a pulse voltage to the thin film resistor were formed on the SiO₂ film 402 (FIG. 4A). The material of the thin film resistor was polycrystalline silicon doped with P (phosphorus) for the electroconductivity. The thin film resistor was covered with an SiN film (not shown in the drawing) as a protection layer.

Another silicon substrate 408 was dry-etched to form open holes serving as sample injection vessels 404 and mixing vessel 405, and grooves serving as flow channels 406 and flow channel 407. This silicon substrate was bonded to silicon substrate 401 having heating element 403 by use of an epoxy adhesive. In the bonding, the relative position of the substrates was adjusted to place heating element 403 in mixing vessel 405 (FIG. 4B).

Then, glass base plate 410 which has sample inlets 409 having been formed by etching was bonded to silicon substrate 408 by anodic bonding. The bonding position was adjusted to place sample inlet 409 above sample injection vessel 404 (FIG. 4C).

The chemical analysis apparatus was completed by the above production process.

With the chemical analysis apparatus shown in FIGS. 3A and 3B, a two-liquid mixing experiment was conducted in which liquid A (an aqueous 10% ammonia solution) and liquid B (a solution of phenolphthalein in ethanol and water (prepared by dissolving 0.5 g of phenolphthalein in 50 mL ethanol and 50 mL water)) were mixed. Before the mixing, the above liquid A and liquid B are colorless and transparent. The liquid mixture is pink in color. Silicone tubes were joined to sample inlets 308, and the liquids were respectively introduced into sample injection vessels 302 through the silicone tubes by a pump. The liquids were respectively introduced through flow channels 304 into mixing vessel 303, and brought into contact with each other in mixing vessel 303. In this state, heating element 306 was driven to cause expansion and shrinkage of bubble repeatedly to stir and mix the liquids in mixing vessel 306. Thereby, the colorless liquids became pink in color. For comparison, the same mixing was conducted without driving the heating element 306. A longer time was necessary for the change of the color of the solution mixture to pink in comparison with the mixing with driving of the heating element.

The liquids may be solutions in water or alcohol other than the above solutions. Any solution may be applicable as the liquid sample provided that the solution is capable of causing film boiling by rapid heating. The chemical analysis apparatus of the present invention is useful for chemical reactions like oxidation-reduction reactions and addition reactions as well as biochemical reactions employing biological components like DNA and proteins.

In this Example, liquids were mixed in the mixing vessel by utilizing expansion and shrinkage of a bubble. Thereby, the liquids could be mixed effectively and uniformly in comparison with the mixing by only diffusion without utilizing bubbling. Furthermore, the mixing vessel could be made smaller in size in comparison with chemical analysis systems of prior art.

1. A method of mixing liquids in a liquid chamber, comprising the steps of
introducing liquids into the liquid chamber, and
repeating expansion and shrinkage of a bubble in the liquids in the liquid chamber.

2. The method of mixing liquids according to claim 1, wherein the liquid is heated for producing the bubble.

3. The method of mixing liquids according to claim 2, wherein heating elements are provided in the liquid chamber, and the heating elements are independently driven respectively.

4. The method of mixing liquids according to claim 2, wherein the power for mixing the liquids is changed by changing the amount of energy supplied to the heating element.

5. A liquid-mixing apparatus for mixing liquids in a liquid chamber, comprising
a liquid chamber;
flow channels for introducing the liquids into the liquid chamber;
a heating part placed in the liquid chamber for heating the liquids in the liquid chamber; and
an energy-supplying means for causing expansion and shrinkage of a bubble in the liquids in the liquid chamber.

6. The liquid-mixing apparatus according to claim 5, wherein the liquids are a specimen and a solvent for the specimen.

7. The liquid-mixing apparatus according to claim 6, wherein the apparatus further comprises a flow channel for delivering the liquids mixed in the liquid chamber to the outside of the liquid chamber, and an analysis means for analyzing a specific component contained in the delivered liquids.

8. The liquid-mixing apparatus according to claim 6, wherein the specimen is a biological component.

9. The liquid-mixing apparatus according to claim 7, wherein the analysis means comprises a separating means for separating the liquid into plural components, and
detecting means for detecting the components.

10. The liquid-mixing apparatus according to claim 9, wherein the separating means is liquid chromatography.
